(19) United States
(12) Patent Application Publication
(10) Pub. No.: US 2018/0160860 A1
(43) Pub. Date: Jun. 14, 2018

(54) Upside-Down Container Bag

(71) Applicant: Paula K. Mitchell, Leesburg, FL (US)

(72) Inventor: Paula K. Mitchell, Leesburg, FL (US)

(21) Appl. No.: 15/372,579

(22) Filed: Dec. 8, 2016

(51) Int. Cl. A47K 3/28; A47K 5/12; B67D 3/00

(52) U.S. Cl. CPC A47K 3/281; A47K 1/09; B67D 3/00; A47K 5/1214

(57) ABSTRACT

A woven or mesh bag which holds a container/bottle of any liquid, upside-down which enables the user to fully, and completely, dispense the contents of the container/bottle. This saves money by eliminating waste of the liquid product inside the container/bottle. The mesh bag is opened and closed by using a drawstring action on top and a cord stop to keep it closed. The ends of the cord are secured using a cord clasp. The container/bottle is inserted into the mesh bag upside-down. The top of the container/bottle protrudes the elastic opening of the mesh bag and is supported, upside-down. This allows the contents inside to flow to the top of the container/bottle's lid or opening. It can then be hung from any hook or other protruding apparatus that can hold the full weight of the container/bottle.

### BACKGROUND OF THE INVENTION

### 1. Field of the Invention

The present invention generally relates to the field of designing and manufacturing of carrying bags such as woven, netting or mesh bags for carrying containers of liquid. More particularly, this invention relates to a tubular carrying bag, open on both ends, with an easy-open and re-closable top. The bottom end uses an elastic trim stitched on top of mesh fabric creating an opening for securing a container, inverted.

### 2. Description of the Related Art

Mesh bags have been widely used in sports, laundering, storing, travel and more. They come in all sizes, shapes, colors and with a variety of uses. You can seal them on top or bottom. They can be zippered or velcro'ed. They can be left open with handles, such as a shopping bag.

This mesh bag does what the others don't do—it holds/carries the container upside-down to easily dispense all the liquid from inside (see FIG. 10). It is open on both ends, forming a top and bottom.

This invention comprises several materials and therefore creates the mesh bag (here forward known as the mesh bag). On one edge of the mesh fabric (FIG. 1), a portion of the fabric is folded over and stitched to form a casing. This creates the top of the mesh bag. The top casing (FIG. 6a, 6b) will house a nylon, cotton, or polyester annular cord, a flat band or lace (FIG. 6c, 6d, 6c). It will be used as a drawstring (here forward known as the drawstring). A two-hole cord stop (FIG. 7a) secures the drawstring which locks into place wherever the user may stop it. The cord stop apparatus consists of various colors, sizes, and shapes. The ends of the drawstring are secured from unraveling with a cord clasp/clamp (FIG. 7b). The cord clasp apparatus consists of various colors, sizes, and shapes. The bottom, opposite the top casing, will have an elastic ribbon, trim, or band consisting of any color, style, or size, that, when straight stitched on top of the netting fabric, will gather the bottom of the mesh bag to create a small opening that is adjustable by stretching. The mesh bag is used to hold inverted containers of liquid (shampoos, lotions, condiments, etc.). This action dispenses all the liquid product from the container with ease.

What is desired is to have a bag, with a one-pull easy-open, re-closable end, for holding a container of liquid upside-down so that all the contents are dispensed without wasting the product, or money. It can be hung from any hook apparatus or knob using the drawstring and cord clamp.

### SUMMARY OF THE INVENTION

This invention solves the issue of dispensing the last few ounces of any liquid encased in a container of most sizes. When trying to get the last bit of shampoo, or lotion, or condiment, out of a container, one has always pounded the container upside-down to get all the liquids to come to the top so that one can get everything out of the container. It, also, solves the issue of turning a container upside down that does not have a flat top to do so. The advantages of using this mesh bag are four-fold: 1) dispensing all the liquid out of the container; 2) saving money by not throwing away a container with left over liquid; 3) it can be used to store a container with no flat top; and 4) carrying bottles of refreshment in the upside-down position, thus allowing an easier maneuver in taking a drink.

One end of the mesh bag is reserved for placing an inverted container inside the bag so that the bag encompasses the container. The opposite end, the bottom, of the mesh bag is reserved for the “top” of the inverted container to protrude. The easy-open drawstring offers both an opening and closing method.

### BRIEF DESCRIPTION OF DRAWINGS

FIG. 1 is a schematic drawing illustrating the folding of the edge of the mesh fabric to form a casing and the stitches that secure it; thus, creating the top of the mesh bag.

FIG. 2 is a schematic drawing illustrating the casing after the excess fabric has been neatly trimmed.

FIG. 3 is a schematic drawing illustrating the elastic ribbon or trim.

FIG. 3a is a schematic drawing illustrating the task of sewing the elastic ribbon to the “right side” of the fabric and stretching it while sewing to the other end.

FIG. 4 is a schematic drawing illustrating the elastic ribbon completed and gathering the mesh fabric.

FIG. 5 is a schematic drawing illustrating the mesh fabric being folded, “right sides” together and stitched on the opening edges to close and secure the bag. It is now a tubular bag with both ends open.

FIG. 6a is a schematic drawing illustrating the start of threading the drawstring (shoelace, band, cord) through the top casing.

FIG. 6b is a schematic drawing illustrating the completed threading of the drawstring.

FIG. 6c is a schematic drawing of a shoelace.

FIG. 6d is a schematic drawing of a roll of trim.

FIG. 6e is a schematic drawing of a cord.

FIG. 7 is a schematic drawing illustrating the mesh bag comprised of all materials mentioned.

FIG. 7a is a schematic drawing illustrating the cord stop apparatus. It consists of different sizes, colors, and shapes.

FIG. 7b is a schematic drawing illustrating the cord clamp apparatus. It consists of different sizes, colors, and shapes.

FIG. 7c is a schematic drawing illustrating the drawstring being put through the eyes of the cord stop apparatus.

FIG. 8 is a schematic drawing illustrating the finished mesh bag.

FIG. 9 is a schematic drawing illustrating an inverted container being inserted into the top opening of the mesh bag.

FIG. 9a is a schematic drawing illustrating an inverted container inside the mesh bag.

FIG. 9b shows the inverted container top protruding the bottom opening of the mesh bag.

FIG. 10 is a schematic drawing illustrating the drawstring action of the cord stop apparatus to close the mesh bag.

FIG. 11 is a schematic drawing illustrating the mesh bag encompassing the inverted container hanging on a hook apparatus.

### DETAILED DESCRIPTION OF THE INVENTION

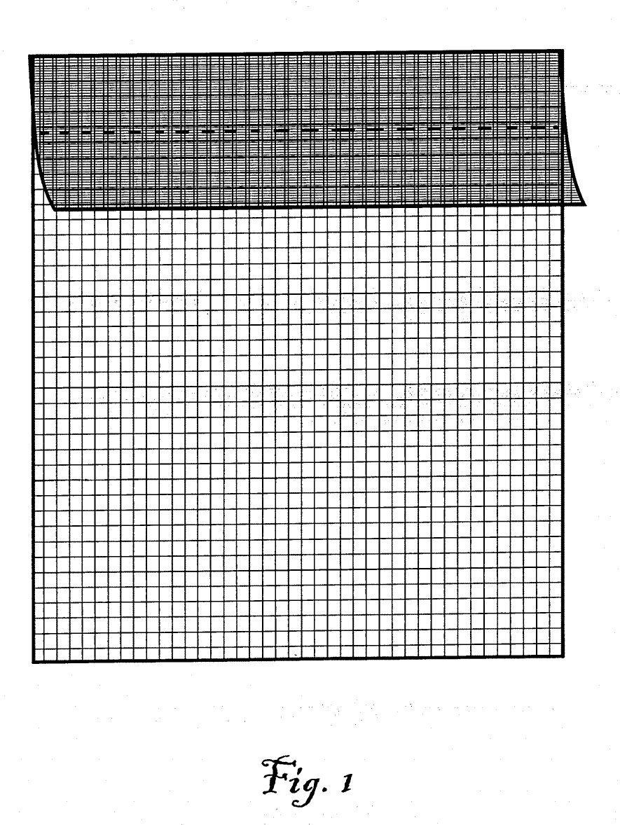

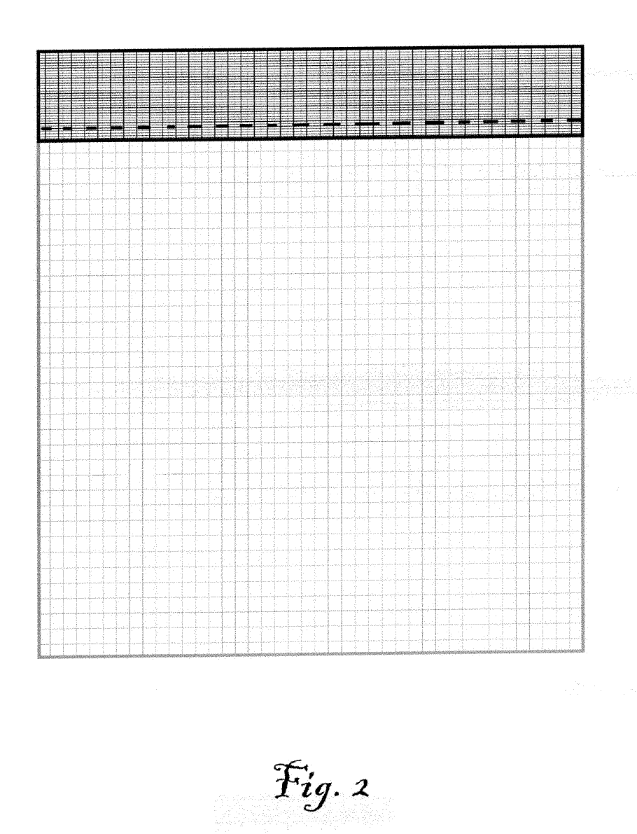

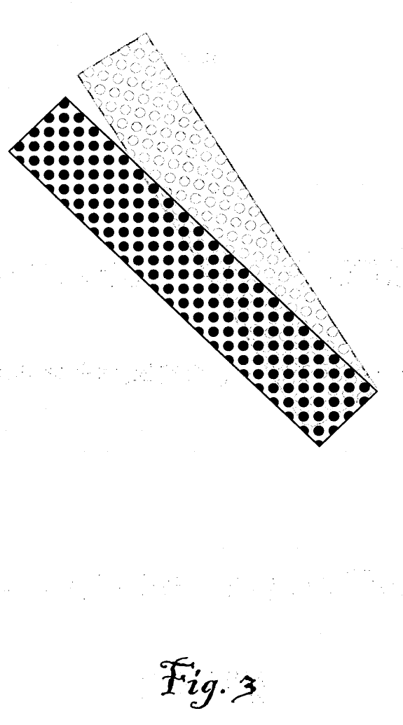

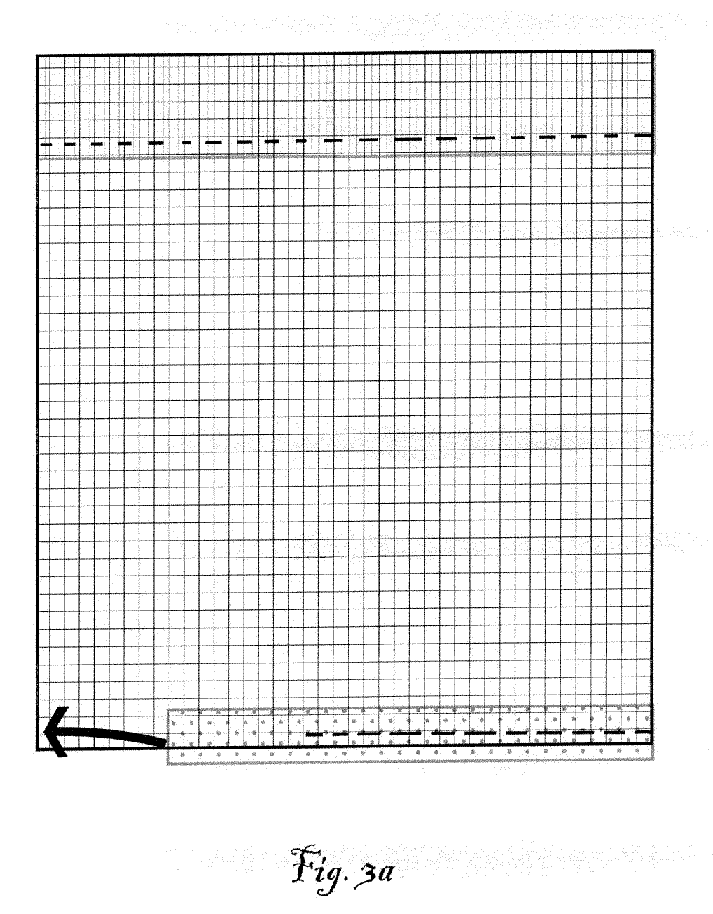

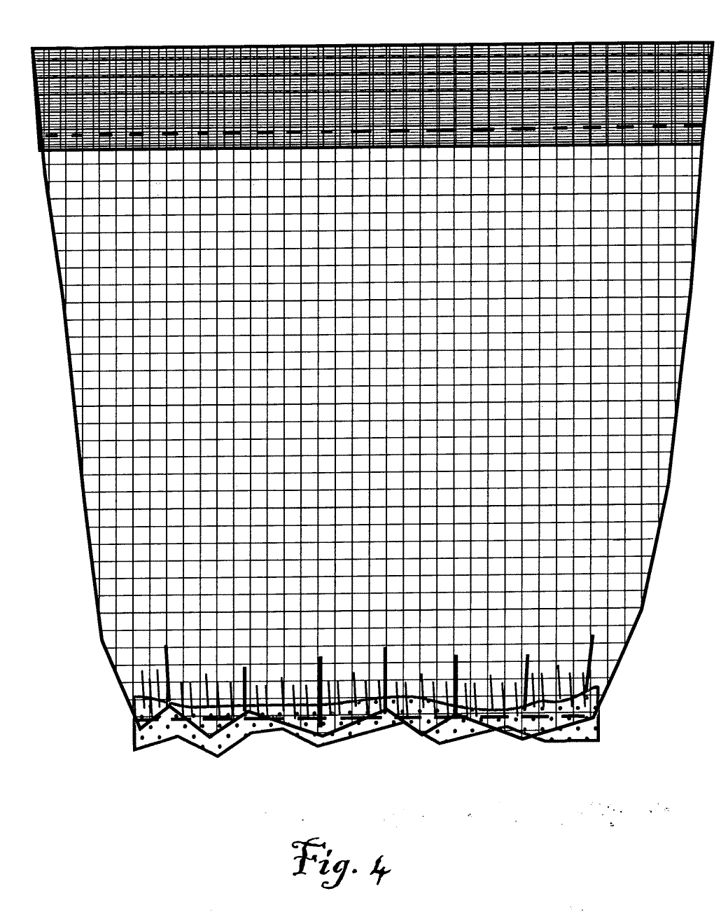

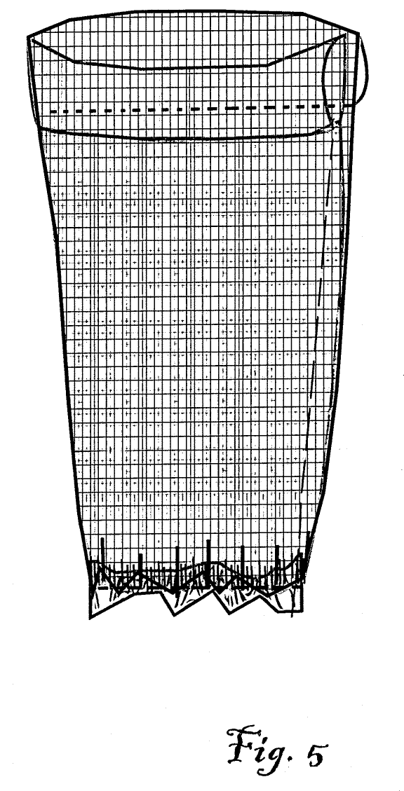

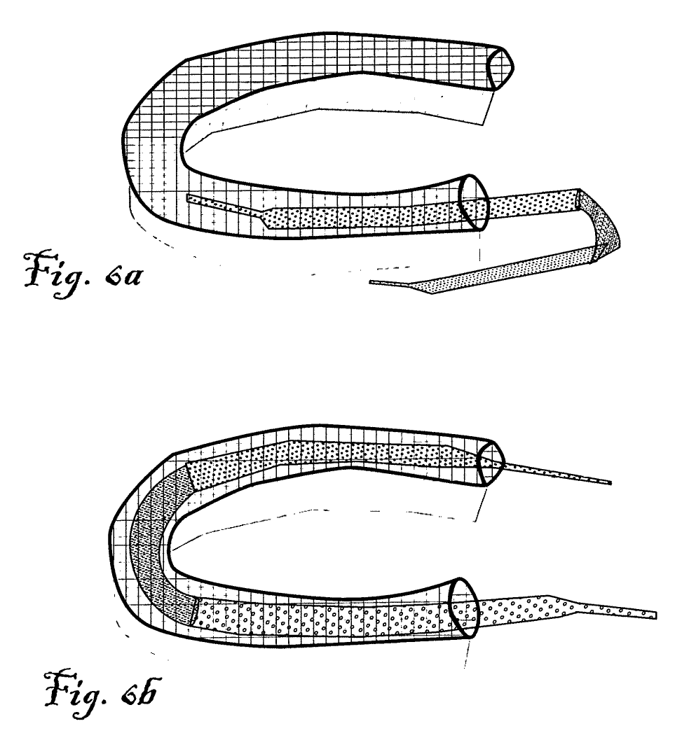

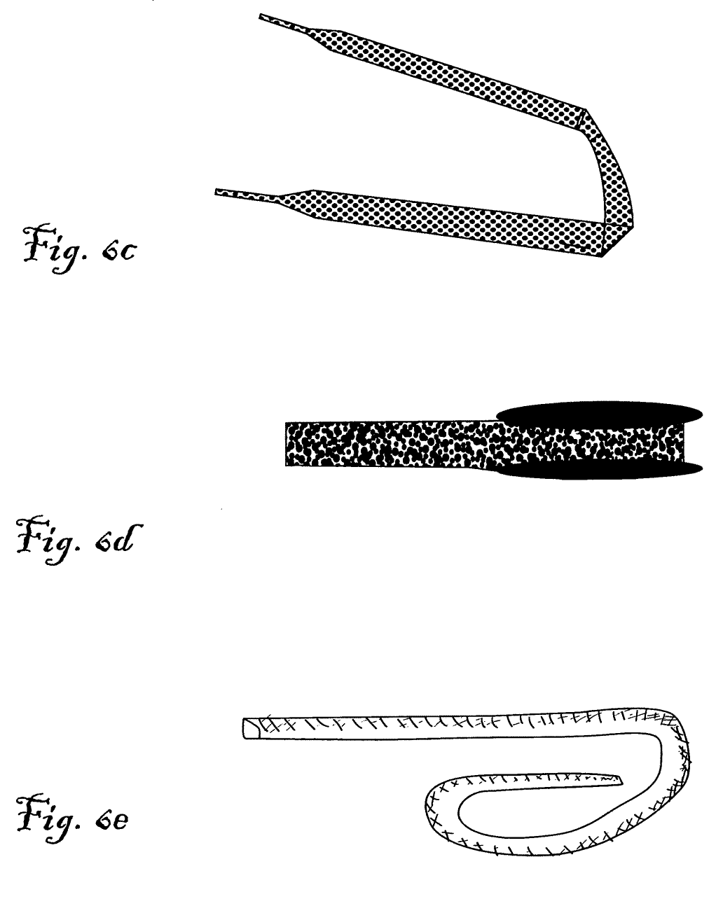

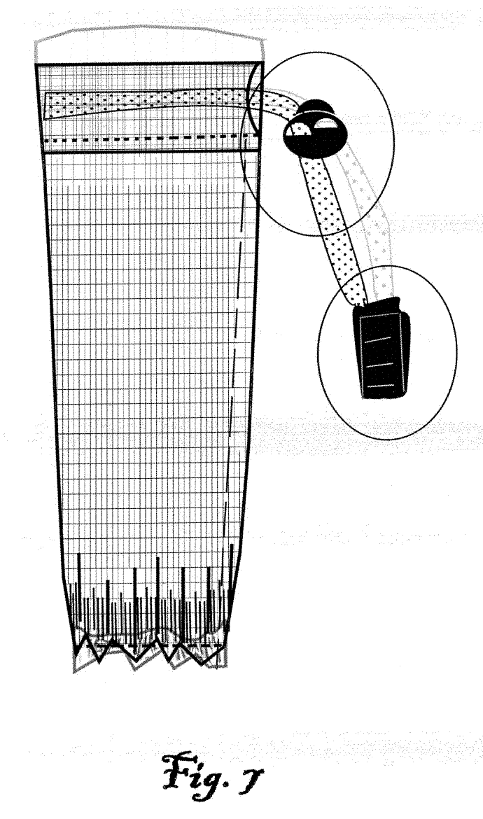

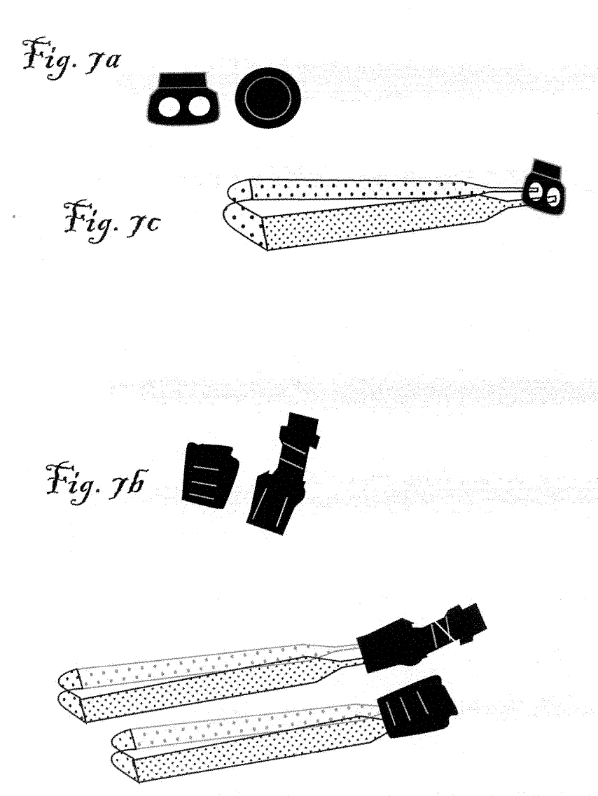

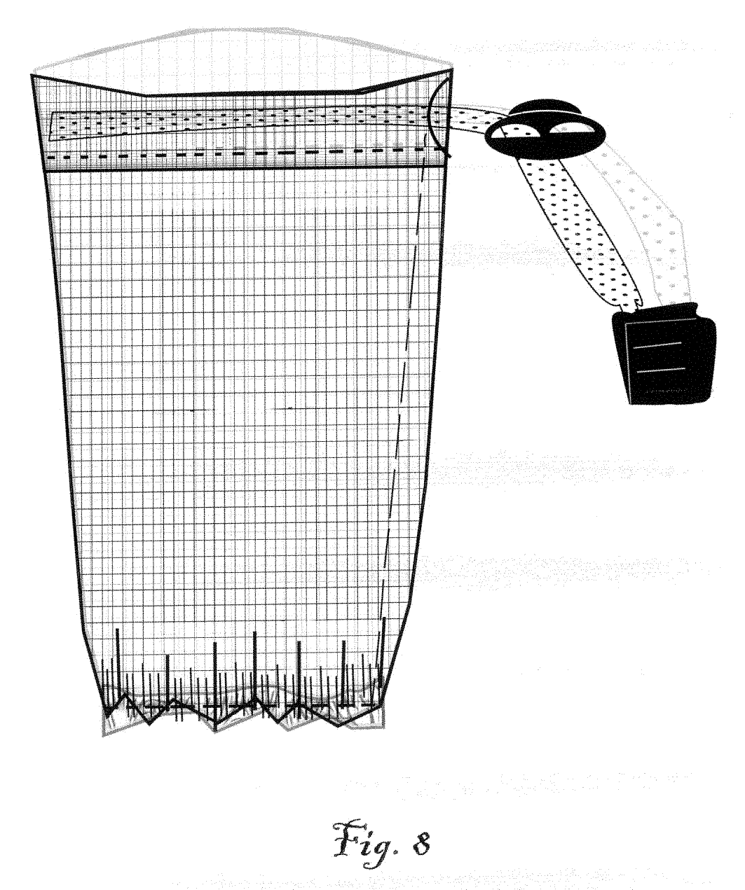

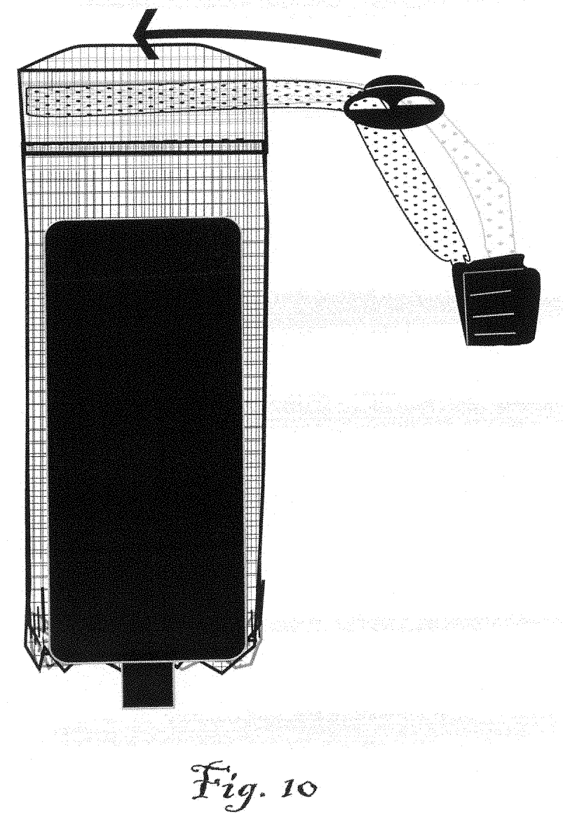

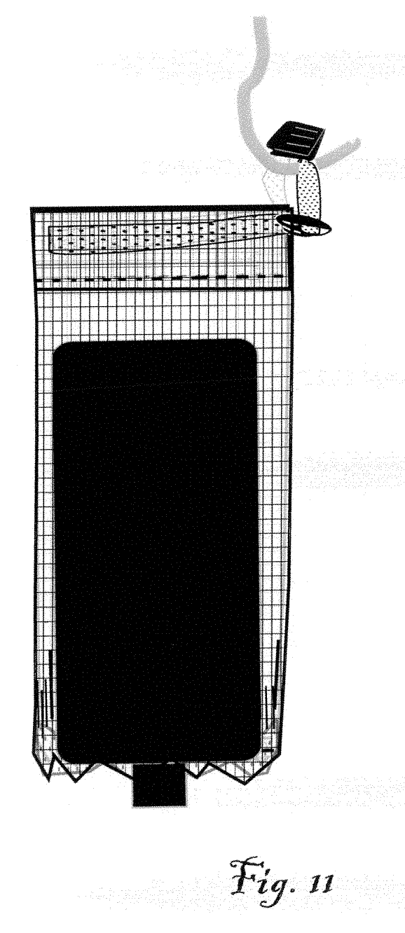

FIG. 8 is a schematic drawing of the mesh bag. FIG. 10 is a schematic drawing illustrating the use of said mesh bag which encompasses and supports inverted containers, such as shampoo bottles, lotion bottles, condiments, and other containers to dispense all the liquid inside. The mesh bag is made of woven, cotton, polyester, nylon or dive mesh fabric 10 (hereafter referred to as mesh fabric or mesh bag) which stretches. It stretches and is flexible enough to support most size containers and most weights of a full container. A piece of mesh fabric 10 is folded over (FIG. 1) 11 on the top, and stitched 12 horizontally, to make a casing 21 (FIG. 2) which will house a nylon, cotton, or polyester cording (FIG. 6e), shoelace (FIG. 6c), band (FIG. 6d), or lace (here after known as the drawstring). The excess fabric 13 near the stitching is trimmed off (FIG. 2) making a neat and clean edge 22. FIG. 3 is a schematic drawing of the elastic trim, band, or ribbon. It consists of a variety of prints, colors, and sizes. FIG. 3a is a schematic drawing illustrating the use of a flat elastic trim, band, or ribbon 31, which is straight, or zig-zagged, stitched 32 on top of the mesh fabric 10 whilst pulling along the bottom 34 of the mesh bag, evenly and proportionately at the edge, from one side to the opposite side 34 horizontally. This method will cinch 41 (FIG. 4), or gather 41, the bottom part of the mesh bag 41. The mesh fabric 10 is folded 52 in half with right sides together (FIG. 5). This forms the tubular effect of the bag. It is then straight stitched 53 with thread 54, color matching the mesh fabric 51, starting at the top stitching 55 of the casing. This will leave the casing open on top 56, thus allowing the threading of the drawstring through the casing (FIG. 6a, 6b). Trim 54 excess threads from mesh bag. Trim the seams excess fabric 57 close to the stitch area 53. This will give it a clean look. Turn the bag right side out. FIG. 6a is a schematic drawing illustrating the head 61 of the shoelace (drawstring) 65 being threaded 66 through the opening 62 at the top 63 of the mesh bag 64. FIG. 6c is a schematic drawing illustrating a shoelace, 6d is a schematic drawing illustrating a spool of trim, ribbon, or band, and 6e is a schematic drawing illustrating a rounded cord. Thread 66 through until it comes through the other end 62 of the mesh bag 64 (FIG. 6b). Pull the ends 61 of the drawstring (shoelace, band, or cord) together to make even (FIG. 7c). Take the cord stop apparatus 74 (FIG. 7a), with the two holes, press down on the button 71 to disengage the locking mechanism and thread each drawstring end through each one of the holes 72. Take the cord clasp apparatus 73 (FIG. 7b) and lay the two cord ends inside 76; then, close it to secure the ends 75 from unraveling. FIG. 8 shows the completed mesh bag.

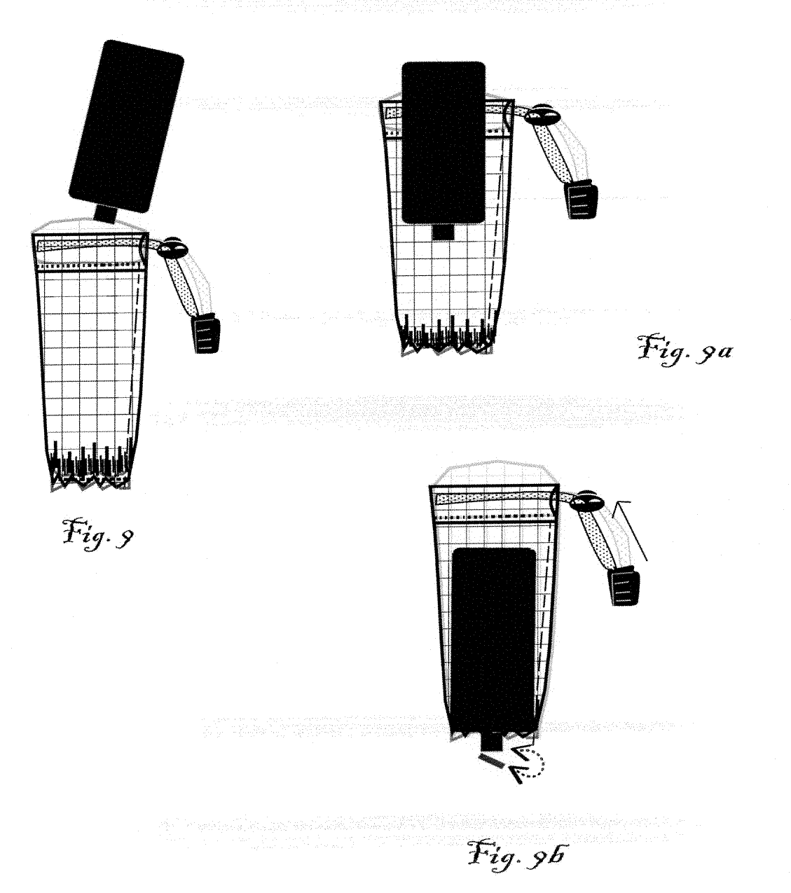

Release the tension on the cord stop (FIG. 9) by pressing down on the button 91 and sliding 92 the cord stop toward the end 93 of the drawstring 65. Take a container and turn it upside-down (FIG. 9) and slide it into the top opening 95 of the bag. The top of the inverted container 96 will go down inside the mesh bag 97. Continue inserting the inverted container down inside the mesh bag 97. The top goes through 98 the elastic opening at the bottom of the mesh bag (FIG. 9b). Once it is through, the container can be opened in its normal operation 99.

FIG. 10 shows the bag and container ready for use. Press the button 101 on the cord stop apparatus 102 to release the locking mechanism. Slide the cord stop 103 towards the opening bag 104 to close and secure the inverted container 105 inside the bag. It can now be hung from the drawstring 111 onto a hook 112 or other hanging apparatus of the user's choice.

The invention claimed is:

1. A carrying device comprising in combination: a woven or mesh fabric folded on one end and stitched, with thread of matching color, to form a tube; a nylon, cotton or polyester cord, lace, or band; an elastic ribbon or trim to gather the bottom mesh fabric to form an opening; a cord stop or lock with two holes to thread through the cord, lace, or band; and a cord clasp to protect the ends of the cord, lace, or band from unraveling. The bag is open on top and utilizes a drawstring action to open and close said bag. The elastic on the bottom forms a secure opening to hold the container in place;

2. The carrying device, of claim 1, comprises a casing when folded over and straight stitched on joining edges;

3. The carrying device, of claim 1, encompasses an inverted container/bottle firmly;

4. The cording device, of claim 1, acts as a drawstring when threaded through the casing on top of the mesh bag;

5. The locking device, of claim 1, a cord stop, which when pressed down, locks and unlocks the pressure holding the drawstring securely;

6. The locking device, of claim 5, opens and closes the top of the mesh bag by sliding to and away from opening;

7. The cording device, of claim 4, also utilizes a cord clamp/clasp that when cord ends are inserted, and the clamp is closed, secures the ends of the cord to prevent unraveling;

8. The carrying device, of claim 1, wherein the bottom of the mesh bag has an elastic ribbon or trim sewn on top of the mesh fabric, to gather together the mesh fabric of claim 1, supporting the container in an upside-down manner;

9. The carrying device, of claim 1, and all its components, can be derived from any color, style or size that will sustain the integrity, creativity, and design of the invention;

10. The carrying device of claim 1, where said tubular bag is made by folding a piece of square or rectangular material from its middle line and seam its two edges which parallel to said middle;

11. The cording of claim 4, wherein said drawstring and said line of easy opening stitches are set in parallel;

12. The elastic device, of claim 8, is straight stitched from one side of fabric to the opposite to form a gathering effect while stretching across;

13. The carrying device, of claim 1, when comprised of all materials, of claim 1, encompasses many types of inverted containers;

14. The carrying device, of claim 1, is hung on a hook apparatus of the user's choosing.
